(19) United States
(12) Patent Application Publication
(10) Pub. No.: US 2011/0272330 A1
(43) Pub. Date: Nov. 10, 2011

(54) Air Sifting or Separating Machine Having Discharge Regulation

(76) Inventors: Richard James Snoby, Roswell, GA (US); Johannes Egon Hümmler, Finnentrop-Fretter (DE)

(21) Appl. No.: 13/092,506

(22) Filed: Apr. 22, 2011

(30) Foreign Application Priority Data
Apr. 23, 2010 (DE) 10 2010 018 226.5

(51) Int. Cl. B07B 4/00

(52) U.S. Cl. 209/146

(57) ABSTRACT

An air sifting or separating machine for dry separation of raw material, including a carrier member having openings and receiving material to be sifted or separated from a material feed mechanism, and a discharge mechanism for heavy material and light material layered on the carrier member during a sifting process. A pulsating air stream is passed through the carrier member to loosen up and layer the material fed to it. A control device for the discharge mechanism is operative via radiometrical measurement of the thickness of the material, and is comprised of a source of radiation mounted on a wall of the machine, and an associated scintillation unit that measures absorption of radiation given off by the source of radiation. The scintillation unit is disposed within a protective pipe freely mounted at a suitably set distance from the source of radiation and within a sifting or separating bed formed by the heavy material layer. The protective pipe is carried by the support mechanism connected to the machine and extending over the carrier member.

The instant application should be granted the priority date of Apr. 23, 2010 the filing date of the corresponding German patent application 10 2010 018 226.5.

### BACKGROUND OF THE INVENTION

The present invention relates to an air sifting or separating machine for a dry separation of raw material, in particular coal, and includes a material feed mechanism, at least one carrier member that is provided with openings, as well as a discharge mechanism for the heavy material and light material that is layered on the carrier member during the sifting or separating process, whereby a pulsating air stream, as working air, passes through the carrier member to loosen up and layer the material fed to the carrier member into a heavy material layer, which acts as a sifting or separating bed, and into a light material layer that is disposed on the heavy material layer, and whereby a control device, for the discharge mechanism, is disposed at that end of the carrier member disposed in the direction of transport of the material, wherein the control device is operative via a radiometrical measurement of the thickness of the material, and wherein the control device is comprised of a source of radiation mounted on a wall of the air sifting or separating machine, and of an associated scintillation unit that is adapted to measure the absorption of the radiation that is given off by the source of radiation.

An air sifting machine generally having the afore-mentioned features is described in DE 20 2005 07 472 U1. By means of a material feed device, the material that is to be processed is fed to a carrier member, which, for example, is in the form of an apertured plate or a wire mesh. By means of an air plenum disposed below the carrier member, an air stream is supplied that is composed of a partial stream that constantly flows through the carrier member, and a pulsating partial stream that overlaps the constant partial stream. As a consequence of the constant air stream acting upon the carrier member and the material resting thereon that is to be processed, a basic fluidization of the material that lies upon the carrier member is achieved, so that a somewhat permanent loosening of the material is obtained, which initially has a relatively low pressure loss as working air flows vertically through the carrier member. Thus, with respect to the pulsating air stream that is introduced in an overlapping manner, a relatively small volume stream of pulsating air is required in order, within the framework of carrying out the process that is inherent to an air sifting machine, to periodically raise and lower the material bed resting upon the carrier member, and to thereby bring about layering of the material into a heavy material layer and a light material layer disposed thereon. Disposed at that end of the carrier member situated in the direction of transport of the material via the carrier member, is a discharge mechanism by means of which the light material layer and the heavy material layer are separately withdrawn. DE 20 2005 007 472 U1 contains no information regarding the control of this discharge mechanism.

However, during use of known air sifting machines it has become known to effect the appropriate control of the discharge mechanism via a measurement of the material thickness at the end of the sifting bed. In particular, a radiometrical measurement method is used for this purpose, which is based on a varying absorption of gamma radiation as a function of the thickness of the material through which the radiation is transmitted. The magnitude of the absorption is determined with the aid of the counter rate of a scintillation unit, which is essentially comprised of a crystal that is excited into luminescence by the ionizing radiation, and a photo diode, which counts the corresponding light emissions. With known sifting machines, this scintillation unit is typically disposed in a housing that in turn is disposed in the radiation path of a source of radiation that gives off the gamma radiation, and is typically mounted on the outside of the wall of the sifting machine opposite the source of radiation, which is also mounted on the outside of a wall.

Unfortunately, such a control device has the problem that due to the aging of the radioactive material in the source of radiation over time, the radiation intensity of the gamma radiation drops, thus making the determination of the absorption via a measuring technique difficult. Furthermore, the source of radiation and the scintillation unit cannot be arbitrarily spaced from one another, since the absorption of the radiation increases with the length of the material layer through which radiation is transmitted, thus also resulting in a degradation of the resolution of the corresponding measurement signals. Since in addition the radiation emitted from the source of radiation widens in a conical manner, the necessary shielding of the radiation cone toward the outside as the distance between the source of radiation and the scintillation unit increases similarly represents a problem. Since ultimately the measurement comprises a counting process, a certain period of time is required in order to obtain a measurement value that has to be processed further for control purposes; such a period of time represents a dead time for the regulation of a discharge member as a discharge device of an air sifting machine, which dead time can not only negatively influence the quality of the product, but can also increase the amount of product that has to be scrapped. In addition, the aforementioned restrictions also mean a limitation of the design of air sifting or separating machines with regard to their width, i.e. the width of the carrier member that is utilized.

It is therefore an object of the present invention to provide an air sifting or separating machine of the aforementioned general type that avoids the aforementioned drawbacks and in particular no longer has a limitation in the design of the width of the air sifting or separating machine due to the control device for the discharge mechanism.

### BRIEF DESCRIPTION OF THE DRAWINGS

This object, and other objects and advantages of the present invention, will appear more clearly from the following specification in conjunction with the accompanying schematic drawings, in which:

FIG. 1 is a side view of an air sifting or separating machine,

FIG. 2 is a front view of the air sifting or separating machine of FIG. 1, including the control device for the discharge mechanism, and

FIG. 3 is a cross-sectional view of the control device showing the scintillation unit disposed in a protective pipe.

### SUMMARY OF THE INVENTION

The basic concept of the present invention is that the scintillation unit is disposed in the interior of a protective pipe, and the protective pipe is freely mounted at a suitably set distance from the source of radiation and within the sifting or separating bed in the stream of material; furthermore, the protective pipe is carried by a support mechanism that is connected with the air sifting or separating machine and extends over the carrier member. The present invention above all has the important advantage that the scintillation unit can now be positioned in any desired position within the air sifting or separating machine.

Further advantages resulting from the present invention include a longer service life of the source of radiation, resulting in a considerable cost advantage. In addition, the possibility is provided of being able to build considerably wider and hence more efficient air sifting or separating machines. Furthermore, the costs for the design of the discharge mechanism, including the control device for controlling it, are no longer dependent upon the width of the machine. The distance between the source of radiation and the scintillation unit, which is possibly reduced due to the disposition of the scintillation unit within the air sifting or separating machine, permits the use of weaker sources of radiation, as a result of which not only is the approval process required for the operation of air sifting or separating machines equipped in this manner simplified, but also the working safety in the area of the air sifting or separating machine is improved. At the same time, the dead time required for counting the pulses is shortened, as a consequence of which the regulation process, and hence the operating result of the air sifting or separating machine, are improved.

Pursuant to alternative specific embodiments of the invention, the support mechanism for the protective pipe that accommodates the scintillation unit can be disposed either above the carrier member or also below the carrier member.

To the extent that the crystal, which during use is excited into luminescence by the radiation given off by the source of radiation, and which is a component of the scintillation unit, must be able to absorb the radiation that strikes the outside of the protective pipe, pursuant to one specific embodiment of the invention the protective pipe, in its region coordinated with the position of the crystal, is provided with at least one open portion, which is closed off by an insert made of a slightly radiation-absorbing material.

To the extent that pursuant to the present invention the protective pipe extends into the stream of material guided over the carrier member, in particular the regions of the protective pipe that enable radiation to pass through are subject to a corresponding wear due to abrasion, so that the corresponding inserts must be replaced in a timely manner. To be able to easily determine the point in time for replacement during inspection of the air sifting or separating machine, the insert can be comprised of two differently colored parts that are disposed one after the other, i.e. successively, and that are made of materials having respectively different colors. If the outer part of the insert is worn away, thus making the differently colored inner part of the insert visible, this is an indication that the insert, with its two parts, must be replaced.

Alternatively, the protective pipe can be provided with an insert in its region that extends about a crystal, which forms one component of the scintillation unit and is excited into luminescence by the radiation; the insert extends about the crystal and is formed of two concentrically and successively disposed sleeves comprised of a slightly radiation-absorbing material, with the material of each sleeve having a different color. In this connection, the protective pipe, with the scintillation unit disposed therein, need not be mounted in a defined orientation relative to the source of radiation, since an all-around coverage of the impinging or entering radiation is possible.

Pursuant to one specific embodiment of the present invention for supporting the aforementioned sleeve-comprising insert, mounted on the protective pipe, which is open at one end, is a holder for a closure cap carried thereby that closes off the protective pipe, whereby an intermediate chamber found between the end of the protective pipe and the closure cap is filled and closed by the sleeve-comprising insert, which is carried by the holder.

To the extent that a scintillation unit is conventional as a functional unit, within the framework of its accommodation in a protective pipe, the scintillation unit is fixed in position within the protective pipe relative to the casing thereof by means of a tensioning mechanism that engages against an axial end of the scintillation unit, whereby in addition the scintillation unit, at its axial end disposed opposite from the tensioning mechanism, can be supported against the closure cap by means of an intermediate layer made of elastic material.

Further specific features of the present invention will be described in detail subsequently.

### DESCRIPTION OF SPECIFIC EMBODIMENTS

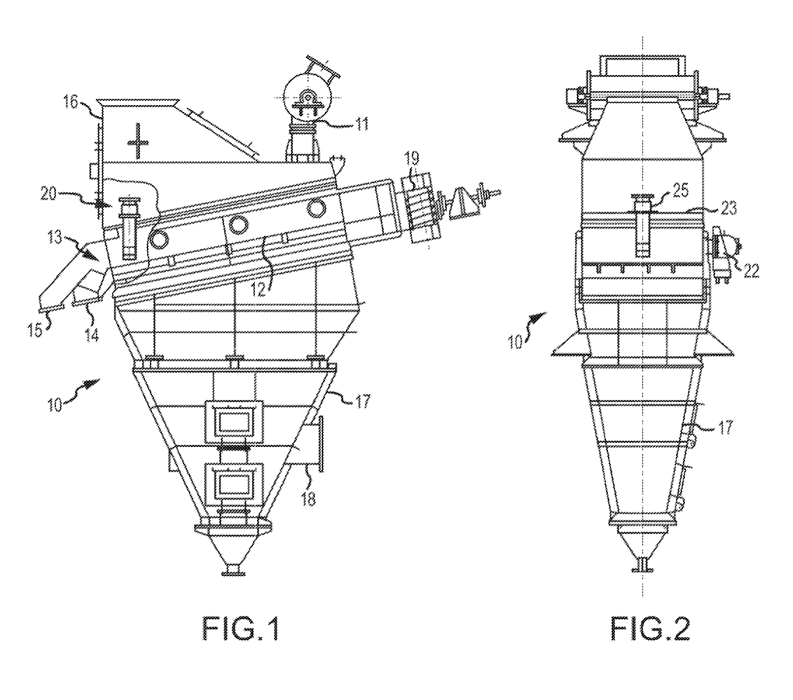

Referring now to the drawings in detail, the air sifting or separating machine 10 illustrated in FIG. 1 has a material feed mechanism 11, by means of which the material that is to be sorted or separated is deposited upon a carrier member 12 for material that is to be sifted or separated, with the carrier member 12 being disposed in the interior of the air sifting machine 10. The carrier member 12 for material that is to be sifted is connected to an oscillator or vibrator 19, by means of which, for the improvement of the material transport along the carrier member 12, movement can be imparted to the carrier member 12. Due to the movement kinematics of the air sifting machine 10, which is known from the state of the art, the material that is fed via the material feed mechanism 11 is, as it is transported over the length of the carrier member 12, layered into a heavy material layer, and into a light material layer formed thereabove, respectively.

Provided at the rear end of the carrier member 12 for material that is to be sifted, which end is disposed opposite the material feed mechanism 11, is a discharge mechanism 13, for example in the form of a weir, which separates the heavy material layer from the light material layer such that the heavy material layer is conveyed into a first discharge chute 14, and the light material layer is conveyed over the weir of the discharge mechanism 13 into a second discharge chute 15.

The air sifting machine 10 is closed off toward the outside by means of a housing 16, which rises above the carrier member 12 for material that is to be sifted, so that the dust that could result during the dry sifting or separation cannot pass into the atmosphere. The exhaust or spent air stream issuing from the carrier member 12 is captured in the housing 16 and is conveyed to a non-illustrated spent air unit, which includes a filter unit. Thus, the environmental pollution is kept appropriately low with such an air sifting machine.

Disposed below the carrier member 12 for material that is to be sifted is an air plenum 17, via which the working air that is required for carrying out the sifting or separating movement is conveyed from below to the carrier member 12, which is embodied as an apertured plate or wire mesh. An air supply line 18 is guided into the air plenum 17. The generation of pulsating working air in such an air plenum 17 is described, for example, in the aforementioned DE 20 2005 007 472 U1.

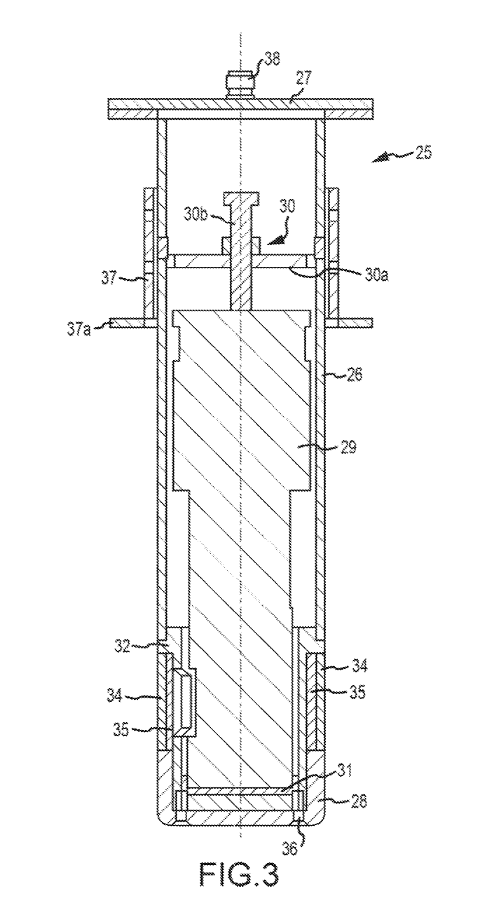

As can be seen from FIG. 1, provided at the end of the carrier member 12 for material that is to be sifted is a control device 20 for the discharge mechanism 13. This control device 20 is comprised of a source of radiation 22 (FIG. 2), and a protective pipe 25. The source of radiation 22 is mounted on the outer side of the housing of the air sifting machine 10 in the vicinity of the carrier member 12, while the protective pipe 25 is mounted in the interior of the sifting bed (see FIG. 1) and accommodates a scintillation unit 29 (FIG. 3). As can be seen in particular from FIG. 2, the protective pipe 25, with the scintillation unit 29, is freely disposed in the interior of the sifting bed above the carrier member 12, and is carried by a support mechanism 23 that extends above the carrier member 12. This support mechanism 23 can, for example, be comprised of plates that on both sides are attached to the housing, and that carry the protective pipe 25, which is supported thereon via a flange. To the extent that with the embodiment illustrated in FIG. 2 the protective pipe 25 is centrally disposed relative to the width of the carrier member 12 for material that is to be sifted or separated, it is also possible pursuant to the present invention to provide any other position relative to the source of radiation 22. In this regard, the spacing between the source of radiation 22 and the protective pipe 25 is freely selectable within the scope of the present invention.

As can be seen from FIG. 3, the upper end of the outer tubular jacket or casing 26 of the protective pipe 25 is closed off by an upper flanged cover 27. Disposed at the bottom end of the protective pipe 25 is a lower closure cap or cover 28, which by means of fastening screws 36 is carried by a holder 32 that is mounted on the tubular casing 26, which is open at one end. In this connection, the lower closure cap 28 maintains a spacing, in the form of an intermediate chamber, relative to the end of the tubular casing 26; this intermediate chamber is closed off by an insert that is carried by the holder 32, and that is formed of two superimposed sleeves 34 and 35 that are respectively made of a slightly radiation-absorbing material that is of a different color for each sleeve.

This configuration of the insert, with its differently colored sleeves 34 and 35, serves for the recognition of wear, to the extent that the protective pipe 25 is mounted in the stream of material guided over the carrier member 12 and hence is subjected to a corresponding abrasive wear. If it is recognizable that the outer sleeve 34 has been worn away, because during an inspection the differently colored sleeve 35 is already visible, it is clear that the insert must be replaced.

A conventional scintillation unit 29 is disposed in the interior of the protective pipe 25 in such a way that its crystal, which is excited into luminescence by the radiation given off by the source of radiation 22, is disposed in the region of the insert composed of the sleeves 34 and 35, so that the radiation can enter the protective pipe 25 in the region of this sleeve insert. With a view toward the functional or operational application, the scintillation unit 29 is braced against the lower closure 28 by means of a tensioning mechanism 30 that engages against one axial end of the scintillation unit. An intermediate layer 31 made of an elastic material is disposed between the lower closure cap 28 and the scintillation unit 29. In the illustrated embodiment, the tensioning mechanism 30 is comprised of a transverse rod or bar 30a, which extends through the protective pipe 25, and a screw arrangement 30b that is inserted in the transverse rod 30a and axially biases the scintillation unit 29.

Furthermore, a retaining mechanism 37 is displaceably and rotatably disposed on the outer side of the tubular casing 26 of the protective pipe 25. The protective pipe 25 can be fixed in position in various axial and radial positions in the retaining mechanism 37, so that an all-around orientation of the scintillation unit 29 on the source of radiation 22 is possible. The retaining mechanism 37 has a flange 37a, by means of which the protective pipe 25 can be fixed in position on the support mechanism 23 of the air sifting or separating machine 10. Finally, the upper cover 27 is additionally provided with a means 38 that allows a cable to be guided through.

The features of the subject matter of the present application disclosed in the specification, the claims, the abstract and the drawings can be important individually as well as in any desired combination with one another for realizing the various embodiments of the invention.

The specification incorporates by reference the disclosure of German priority document 10 2010 018 226.5 filed Apr. 23, 2010.

The present invention is, of course, in no way restricted to the specific disclosure of the specification and drawings, but also encompasses any modifications within the scope of the appended claims.

What we claim is:

1. An air sifting or separating machine for a dry separation of raw material, comprising:
a material feed mechanism;
at least one carrier member that is provided with openings and is adapted to receive material from said material feed mechanism that is to be sifted or separated;
a discharge mechanism for heavy material and light material layered on said carrier member during a sifting or separating process;
means for passing a pulsating air stream, as working air, through said carrier member to loosen up and layer the material fed to said carrier member into a heavy material layer, which acts as a sifting or separating bed, and into a light material layer that is disposed on the heavy material layer;
a control device, for said discharge mechanism, disposed at a downstream end of said carrier member as viewed in a direction of transport of the material, wherein said control device is operative via a radiometrical measurement of a thickness of the material, and wherein said control device is comprised of a source of radiation mounted on a wall of said sifting or separating machine, and of an associated scintillation unit that is adapted to measure absorption of radiation given off by said source of radiation;
a protective pipe, wherein said scintillation unit is disposed within said protective pipe, and wherein said protective pipe is freely mounted at a suitably set distance from said source of radiation and within the sifting or separating bed in a stream of the material; and
a support mechanism for carrying said protective pipe, wherein said support mechanism is connected to said sifting or separating machine and extends over said carrier member.

2. An air sifting or separating machine according to claim 1, wherein said support mechanism is disposed above said carrier member, and wherein said protective pipe, with said scintillation unit, is supported on said support mechanism.

3. An air sifting or separating machine according to claim 1, wherein said support mechanism is disposed below said carrier member, and wherein said protective pipe, with said scintillation unit, is secured to said support mechanism in an upright arrangement.

4. An air sifting or separating machine according to claim 1, wherein a crystal is provided as a component of said scintillation unit, further wherein said crystal is adapted to be excited into luminescence by radiation from said source of radiation, further wherein said protective pipe is provided with at least one open portion in a region that is coordinated with a position of said crystal, further wherein an insert is provided for closing off said at least one open portion, and wherein said insert is made of a slightly radiation-absorbing material.

5. An air sifting or separating machine according to claim 4, wherein said insert is comprised of two differently colored parts that are disposed one after the other and are respectively made of a different colored material.

6. An air sifting or separating machine according to claim 1, wherein a crystal is provided that forms a component of said scintillation unit and is adapted to be excited into luminescence by radiation from said source of radiation, further wherein said protective pipe is provided with an insert in a region that extends about said crystal, further wherein said insert extends about said crystal and is formed from two concentrically and successively disposed sleeves (34, 35), and wherein said sleeves are respectively comprised of a slightly radiation-absorbing and differently colored material.

7. An air sifting or separating machine according to claim 6, wherein said protective pipe has an open end, further wherein a holder is mounted on said protective pipe, further wherein said sleeve-comprising insert is carried by said holder, further wherein a protective cap is carried by said holder for closing off said open end of said protective pipe, further wherein an intermediate chamber is provided between said open end of said protective pipe and said closure cap, and wherein said intermediate chamber is filled and closed by said sleeve-comprising insert.

8. An air sifting or separating machine according to claim 1, wherein a tensioning mechanism is provided that engages against an axial end of said scintillation unit, and wherein said scintillation unit is fixed in position within said protective pipe relative to a casing of said protective pipe by means of said tensioning mechanism.

9. An air sifting or separating machine according to claim 8, wherein a closure cap is provided for closing off an open end of said protective pipe, and wherein said scintillation unit, at an axial end thereof that is disposed opposite said tensioning mechanism, is supported against said closure cap by means of an intermediate layer made of elastic material.
